(19) United States
(12) Patent Application Publication
(10) Pub. No.: US 2026/0360192 A1
(43) Pub. Date: Nov. 12, 2026

(54) REMOTE MONITORING SYSTEM AND METHOD FOR MARINE SURVIVAL CRAFT

(71) Applicant: SURVIVAL SYSTEMS INTERNATIONAL, INC., Valley Center, CA (US)

(72) Inventors: Samuel DYE, VALLEY CENTER, CA (US); James CATANESE, VALLEY CENTER, CA (US); Mark PRYOR, VALLEY CENTER, CA (US)

(73) Assignee: SURVIVAL SYSTEMS INTERNATIONAL, INC., Valley Center, CA (US)

(21) Appl. No.: 19/669,904

(22) Filed: May 6, 2026

Related U.S. Application Data
(60) Provisional application No. 63/800,885, filed on May 6, 2025.

(51) Int. Cl. G07C 5/00; B63B 79/10; B63B 79/20; B63B 79/30; G07C 5/08

(52) U.S. Cl. CPC G07C 5/008; B63B 79/10; B63B 79/20; B63B 79/30; G07C 5/0808; G07C 5/0825; G07C 5/085

(57) ABSTRACT

A system and method for remotely monitoring critical systems of a marine vessel, such as a Totally Enclosed Motor Propelled Survival Craft (TEMPSC), equipped with a diesel engine lacking an integrated engine control unit (ECU). The system includes a retrofit remote monitoring assembly coupled to sensors and actuators within the vessel and configured to collect, process, and transmit sensor data representing operational parameters of the vessel. A computing apparatus receives the sensor data and determines vessel operability based on the sensor data using rule-based logic, AI-based models trained on historical vessel and repair data, or a combination thereof. A graphical interface provides remote visualization of vessel status and predictive maintenance recommendations.

### RELATED APPLICATIONS

This application claims the benefit of U.S. Provisional Application No. 63/800,885 filed on May 6, 2025, the entirety of which is incorporated herein by reference.

### TECHNICAL FIELD

This document generally relates to remote monitoring, diagnostics, and predictive maintenance systems for marine vessels, including Totally Enclosed Motor Propelled Survival Craft (TEMPSC) vessels and other marine survival craft.

### BACKGROUND

A Totally Enclosed Motor Propelled Survival Craft (“TEMPSC”) is a type of lifeboat designed for use on ships and offshore installations as a means of evacuating personnel during emergencies such as fire, sinking, or other disasters at sea. As the name suggests, a TEMPSC is fully enclosed, providing protection from adverse weather conditions, high waves, and rough seas. This enclosure helps to keep occupants safe and dry during evacuation. Unlike traditional lifeboats, which might rely solely on oars or sails, a TEMPSC is equipped with a motor for propulsion. This enables it to navigate through the water more efficiently, especially in adverse conditions or when rescuing individuals from larger vessels.

TEMPSCs must meet stringent international regulations and standards set by organizations such as the International Maritime Organization (IMO) to ensure their effectiveness and safety. These regulations cover aspects such as design, construction, equipment, maintenance, and training. TEMPSCs are typically stowed aboard ships or offshore installations in designated locations for quick and easy deployment in the event of an emergency. They may be launched manually or automatically, depending on the vessel's design and safety systems. However, a key feature of the successful TEMPSC launch is maintaining operability of all its on-board critical systems. Presently, the critical systems are checked during scheduled inspections. That is, the operational readiness is only as good as the results of the last inspection. This is especially relevant for unmanned facilities where frequent inspections are not possible. Accordingly, presently existing solutions fail to provide methods for real-time remote monitoring of critical components or systems of lifeboats. TEMPSCs are commonly deployed on offshore platforms, commercial vessels, and other remote marine installations where maintenance personnel may not be continuously present. Many TEMPSCs utilize diesel engines and supporting electrical systems that lack integrated electronic control units (ECUs), digital telemetry systems, or onboard diagnostics capable of remote monitoring. As a result, operational readiness of such vessels is often determined only during periodic manual inspections.

This creates significant technical limitations. Failures associated with batteries, starter systems, fuel systems, air pressure systems, alternators, cooling systems, or other critical vessel systems may remain undetected between inspection intervals. These limitations are particularly problematic for unmanned or infrequently visited offshore facilities where emergency survival craft must remain continuously deployable.

Existing marine monitoring systems generally assume the presence of modern digital engine management systems and therefore are not readily adaptable to legacy marine engines operating primarily through analog electrical and mechanical systems. Accordingly, presently existing systems fail to provide effective retrofit architectures for real-time remote monitoring, diagnostics, predictive maintenance, and operability assessment of legacy TEMPSC vessels and similar marine survival craft.

### SUMMARY

Disclosed herein are systems and methods for real-time remote monitoring of lifeboats or similar marine vessels, including vessels not equipped with integrated engine control units (ECUs) or digital engine management systems. The system includes a retrofit remote monitoring assembly that integrates with mechanical and electrical components of a diesel engine, such as sensors for oil pressure, fuel level, battery voltage, and temperature, as well as actuators such as fuel solenoids. The apparatus collects sensor data and transmits the sensor data to a computing server for analysis.

The computing apparatus analyzes the sensor data to determine vessel operability and generate predictive maintenance recommendations. In some embodiments, the computing apparatus uses rule-based logic, AI-driven analytics, machine learning models trained on historical repair and sensor data, or a combination thereof. A graphical user interface allows users to visualize engine parameters, diagnostics, operability determinations, and maintenance recommendations. Communication may be facilitated via satellite, cellular, or other wireless networks.

This system addresses a critical need in unmanned or infrequently visited installations, such as offshore platforms, where manual inspection of lifeboats may be insufficient to ensure operational readiness. By enabling remote diagnostics and predictive maintenance, the disclosed technology enhances safety, compliance, and cost-efficiency.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example remote monitoring system, according to an implementation of the disclosure.

FIG. 2 illustrates a schematic diagram of an electrical circuit of an example diesel engine of the remote monitoring system of FIG. 1, according to an implementation of the disclosure.

FIG. 3 illustrates a schematic diagram of an example apparatus for monitoring and controlling of the engine of the remote monitoring system of FIG. 1, according to an implementation of the disclosure.

FIG. 4 illustrates an exemplary schematic diagram of a computer-based architecture of an exemplary computing apparatus of the remote monitoring system of FIG. 1, according to an implementation of the disclosure.

FIG. 5 illustrates a schematic AI modeling module of the exemplary computing apparatus of the remote monitoring system of FIG. 1, in greater detail, including a general flow of data, according to an implementation of the disclosure.

FIG. 6 illustrates an example graphical user interface (GUI) for use with the remote monitoring system, according to an implementation of the disclosure.

FIG. 7 illustrates an example computing system that may be used in implementing various features of embodiments of the disclosed technology.

Described herein are systems and methods for improving collection of real-time marine vessel data in TEMPSCs or similar marine vessels not equipped with digital engine management systems (EMS) or engine control units (ECUs). The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

As alluded to above, TEMPSCs or similar boats that are not equipped with sensors or modules for collecting and transmitting engine and other critical system data and require manual inspection to ensure craft's operational readiness. Furthermore, TEMPSCs are often built with internal combustion engines that do not incorporate digital components and technology such as digital engine management systems (EMS) or engine control units (ECUs) that use digital sensors and processors to monitor and control various aspects of engine operation. Without such digital diagnostic tools and onboard computer systems TEMPSCs are unable to provide real-time feedback and diagnostics to help monitor engine health and detect issues before they become significant problems.

Many existing TEMPSC vessels remain in operation for extended service lifetimes and therefore utilize legacy diesel engines designed without integrated digital telemetry capabilities. Replacing such engines with fully digital systems may be prohibitively expensive, operationally impractical, or incompatible with existing marine certifications, vessel layouts, wiring configurations, or safety approvals.

Accordingly, the present disclosure provides a retrofit architecture configured to interface with existing analog electrical and mechanical engine systems without requiring replacement of the underlying propulsion system. In some embodiments, the retrofit architecture may connect to preexisting sensors, gauges, switches, relays, solenoids, wiring harnesses, battery circuits, or instrument panel connections. The retrofit architecture may obtain analog sensor outputs from existing engine components and convert such outputs into digital telemetry data suitable for remote transmission, analysis, and predictive maintenance operations.

In some embodiments, the retrofit architecture may be installed as a supplemental monitoring system that does not require replacement of the engine, replacement of the vessel control panel, or material alteration of certified survival craft structures. This allows remote monitoring capabilities to be added to legacy TEMPSC fleets while preserving existing vessel configurations.

The present embodiments solve the foregoing technical problems by providing a remote monitoring assembly and system adapted for installation on TEMPSCs and similar marine vessels not equipped with integrated ECUs or digital engine management systems.

As used herein, “operability” may refer to the ability of a marine vessel to successfully perform one or more emergency functions, including engine starting, propulsion, steering, launch readiness, electrical power availability, fuel availability, air pressure sufficiency, battery readiness, and sustained emergency operation. In some embodiments, operability may further include a projected ability to remain deployable within a future time interval based on detected degradation trends or predicted failure events.

As used herein, “critical systems” may include propulsion systems, starter systems, fuel systems, battery systems, alternator systems, air pressure systems, cooling systems, steering systems, emergency communication systems, launch systems, ventilation systems, and other systems associated with emergency deployment or operation of a marine survival craft.

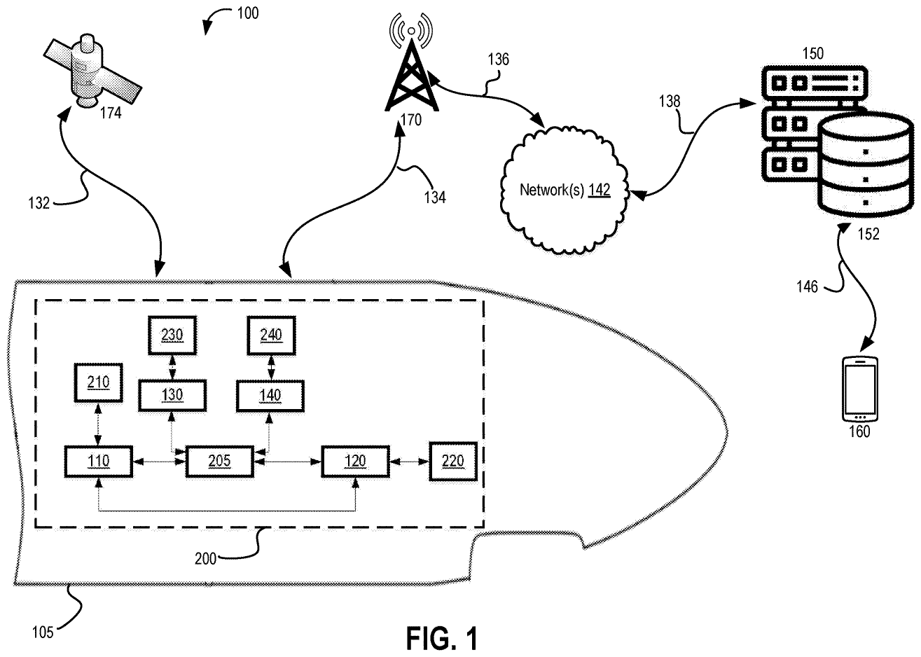

Referring to the drawings, wherein like reference numerals correspond to like or similar components throughout the several figures, FIG. 1, consistent with embodiments disclosed herein, illustrates a remote monitoring system 100 according to an exemplary embodiment. The system 100 includes a marine vessel 105 that has been fitted with a remote monitoring assembly 200 that is illustrative of the concepts described herein. The marine vessel 105 includes, in one embodiment, an enclosed boat that is used on commercial vessels, cruise ships, and off-shore platforms. The marine vessel 105 includes an engine 110, an instrumental and start panel 120, at least one battery 130, and a fuel tank 140.

The system 100 described herein may be used to control, monitor or otherwise be part of, or communicate with, the vessel engine, such as the engine 110. As described herein, the system may be implemented in a vessel with an engine without an integrated ECU.

The engine 110 may be an internal combustion engine, such as BUKH+BETA 48 (BBV2003) marine diesel engine. The engine 110 may uses compression ignition to burn fuel (such as gasoline, diesel, or ethanol) and creates pressure that is converted to a motion. In this engine, air is compressed to a high pressure and temperature, and fuel is then injected into the hot compressed air, causing the fuel to ignite and produce power.

In some embodiments, the engine 110 may be powered by energy extracted from the surrounding environment, such as solar or wind energy. Alternatively, or in addition, the vessel 105 may include an energy storage, and the energy may be converted to generate the vehicle motion.

Diesel engines are known for their high efficiency and durability, making them suitable for a wide range of applications, from automotive to industrial use. In a diesel engine without an integrated Electronic Control Unit (ECU), the electrical components are generally simpler compared to modern engines with advanced electronics. These components work together to ensure the engine starts, runs, and is monitored properly, even without the advanced control provided by an ECU. The systems in a non-ECU diesel engine are generally more mechanical and less reliant on complex electronic management, making them robust but less efficient in terms of emissions control and fuel economy compared to modern engines with integrated ECUs.

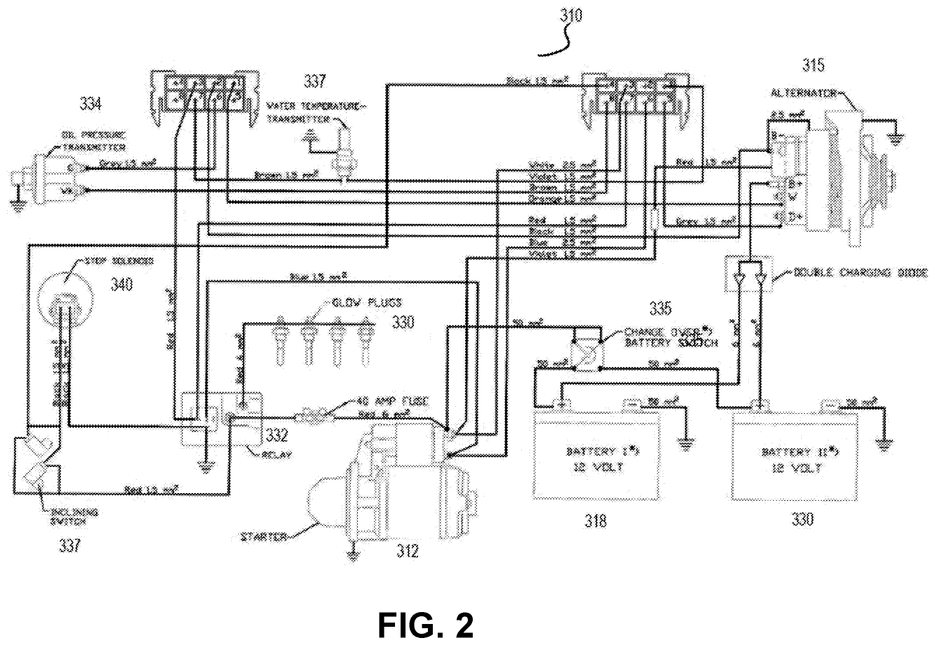

The exemplary diesel engine 110 comprise primary electrical components including a starter motor, an alternator, at least one battery, an ignition switch, glow plugs, relays and fuses, sensors, wiring harness, an instrument panel, and a fuel shut-off solenoid. An exemplary wire diagram of an electrical circuit 310 associated with such an engine is illustrated in FIG. 2. For example, the circuit 310 of engine 110 (illustrated in FIG. 1) may include a starter motor 312 used for cranking the engine to initiate the combustion process and may include a solenoid and a powerful electric motor (not shown). Next, the circuit 310 includes an alternator 315 used to generate electrical power to charge the battery and supply power to the electrical systems when the engine is running and may include a rotor, stator, rectifier, and a voltage regulator, among other components (not shown). Battery 318 and 330 for providing electrical power to start the engine and supply power to electrical components when the engine is off may be included. The circuit 310 includes a change-over battery switch 335 which switches the battery voltage to the engine's ignition coil to initiate the start of the engine. The battery change-over switch 335 is an essential component in systems that require the use of multiple batteries. In diesel internal combustion engines, particularly those used in applications such as marine, recreational vehicles (RVs), or backup power systems, a battery change-over switch allows seamless switching between two or more batteries to ensure a continuous power supply. The battery change-over switch 335 enables the selection and switching between multiple batteries or battery banks. This ensures that if one battery becomes discharged, another can be used without interrupting the power supply to the engine and associated electrical systems.

The circuit 310 also includes an ignition switch 337 for activating the electrical system and starter motor 312. Glow plugs 330 preheat the combustion chambers to facilitate starting in cold conditions. A relay 332 (and a fuse, not shown) is used to control the flow of electricity to various components and protect the electrical circuits from overloads via electromagnetic switches (relays) and fusible links (fuses).

The circuit 310 also includes a plurality of sensors for monitor various engine parameters and ensure proper operation. For example, the circuit 310 includes an oil pressure sensor 334, water temperature sensor 337, and fuel pressure sensor (not shown). Notably, without an ECU, the role of sensors is limited to providing data for basic gauges and safety cut-offs rather than fine control of engine operation. However, by implementing the apparatus 205 (illustrated to FIG. 1) allows monitoring and controlling of the engine parameters even in diesel engine without an integrated ECU.

Next the circuit 310 also includes a wiring harness (not shown) which distributes electrical power and signals throughout the engine and an instrument panel (not shown which provides the operator with information about engine performance and status. The instrument panel may include a tachometer, an oil pressure gauge, a temperature gauge, a battery voltage gauge, among others. A fuel shut-off solenoid 340 controls the flow of fuel to the engine, typically used to stop the engine and may include a solenoid actuator and a valve mechanism.

Finally, a plurality of actuators (not shown), which include devices that control engine functions like fuel injection and throttle position, may be present.

Referring back to FIG. 1, a remote monitoring assembly 200 may be installed within the marine vessel 105 and may comprise an apparatus 205 configured to generate, process and transceive vessel engine related data through a communication interface, for example. The apparatus 205 may be configured to download and locally execute software program code. The software program code may be a client application of a service whose possible server application is running on a computing apparatus 150.

Connecting a diesel engine 110 (without an integrated ECU) to apparatus 205 includes installing the apparatus within the vessel 105, installing and wiring sensors and actuators, and configuring the module to monitor and control engine parameters. This setup allows the apparatus 205 to manage engine operations efficiently, providing enhanced control and monitoring capabilities. Proper installation and configuration are crucial to ensure reliable performance and accurate engine management.

In some embodiments, the apparatus 205 may include analog-to-digital conversion circuitry configured to convert analog sensor signals into digital telemetry data. The apparatus 205 may further include signal conditioning circuitry including filtering, amplification, voltage normalization, isolation circuitry, multiplexing circuitry, and calibration logic configured to improve signal reliability in marine operating environments.

In some embodiments, sensor data may be sampled at predetermined polling intervals, continuously monitored, or captured in response to one or more triggering events, including threshold crossings, abnormal voltage conditions, pressure deviations, temperature deviations, failed start attempts, or operator-initiated diagnostic requests. The sampled sensor data may be processed using threshold analysis, trend analysis, anomaly detection, rule-based diagnostic logic, or predictive modeling techniques.

The apparatus 205 may be mounted within the vessel 105. The apparatus 205 is configured to monitor and control diesel engines which may not include an integral ECU. The apparatus 205 may provide comprehensive control and monitoring capabilities, including handling analog signals from various sensors, managing alarms, and performing automatic start/stop functions associated with the engine 110.

The integration of analog signals into the apparatus 205 involves connecting sensors to the module's analog inputs, ensuring proper wiring and shielding, and calibrating the system to accurately interpret sensor outputs. The apparatus 205 processes these signals to monitor and control engine parameters, ensuring reliable and efficient engine management. This setup allows the external engine control module to effectively replace an integrated ECU in managing the diesel engine's performance.

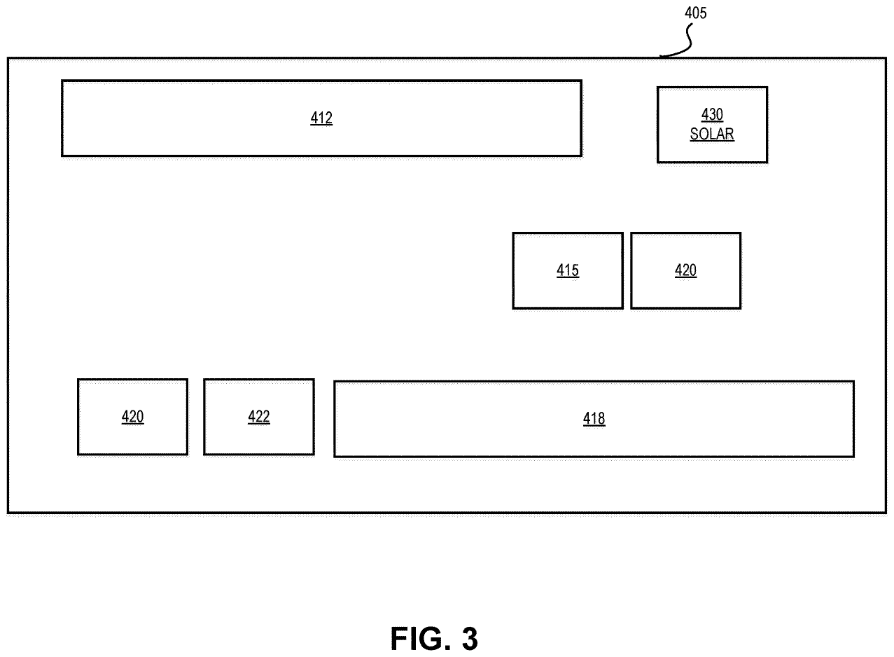

An exemplary diagram of such an apparatus is illustrated in FIG. 3. For example, apparatus 405 may include a plurality of input ports 412 and a plurality of output ports 418. The input ports 412 may be configured to receive input from sensors (e.g., oil pressure sensor and the output ports 418 may be configured to control functions of the engine. For example, the apparatus 405 may include a fuel output 420 and a start output 422. Further, the apparatus 405 may include an Ethernet port 415 used for point-to-point cable connection of more than one device and allows for connection to computing devices. For example, Ethernet port 415 may be configured to connect the apparatus 405 with a broadband modem (such as DSL or cable modem), a firewall, a router, a packet-switch, and a Wireless Access Point (WAP). In some embodiments, the apparatus 405 may be connected to a local computing device (e.g., located on board of the vessel), which in turn may be used to communicate with a remote computing server.

The apparatus 405 may also include a USB port 420 which is configured to provide means of connection between a computing device and the apparatus 405. The apparatus 405 may include a solar port 430.

The apparatus 405 may include a solar port 430 configured to receive electrical power from one or more solar panels installed on the marine vessel. In some embodiments, solar-generated power may be used to charge onboard batteries, maintain operation of the remote monitoring assembly during inactive vessel periods, provide backup power redundancy, or support low-power telemetry and sensor monitoring functions while the vessel is stowed or otherwise inactive.

The apparatus 405 may be mounted in close proximity to the engine 110 (Illustrated in FIGS. 1-2) compartment, ensuring that there is a clear path from the engine compartment to the mounting location of the apparatus 205. Furthermore, wiring loom, as well as the Ethernet cable associated with Ethernet port 415 and/or USB cable associated with USB port 420, and solar panel cables associated with the solar port 430 and have sufficient slack to enable them to be connected and disconnect when required.

As alluded to earlier, the diesel engine without the integrated ECU may only have a select number of sensors which may be limited to what data they provide. Accordingly, to ensure that apparatus 405 can perform the monitoring and controlling of the engine parameters functions, additional sensors may be installed on the engine if they are not already present. For example, an RPM sensor, a fuel level sensor, a battery voltage sensor may be installed. Referring back FIG. 1, the present embodiment shows installation of an air pressure sensor 210 and a fuel sender sensor 240. In some embodiments, air pressure sensor 210 may be installed within a pressurized air cylinder located above the engine 110 compartment. Connections from a wiring harness, described in connection with FIG. 2, may be run to the air pressure sensor 210. For example, the air pressure sensor 210 output may be connected to air pressure input on the apparatus 405. This will ensure that data collected by the sensor 210 may be transmitted to apparatus 205.

In some embodiments, a fuel sender sensor 240 may be installed within the fuel tank 140 of the vessel 105. Again, connections from the wiring harness, described in connection with FIG. 2, may be run to the fuel sender sensor 210. For example, the fuel sender sensor 240 output may be connected fuel sender input on the apparatus 405. The data collected by the sensor 240 may be transmitted to apparatus 205.

In some embodiments, the oil pressure sensor (e.g., oil pressure sensor 334 illustrated in FIG. 2) output may be connected fuel sender input on the apparatus 405. Similarly, the water temperature sensor (e.g., water temperature sensor 337 illustrated in FIG. 2) output may be connected fuel sender input on the apparatus 405.

In some embodiments, output from the change-over battery switch 220 (e.g., the change-over battery switch 335 illustrated in FIG. 2) may be connected to the instrument panel 120 for viewing. As described above, a change-over battery switch switches the battery voltage to the engine's ignition coil to initiate the start of the engine.

In some embodiments, battery monitoring inputs 230 may be run from the battery 130 installed on the vessel 105 to the apparatus 205, thereby allowing the data associated with the battery 130 to be transmitted to the apparatus 205.

A plurality of actuators such as the fuel solenoid and throttle actuator may be connected to the apparatus 205. This allows the module to control engine functions like starting and stopping the engine, as well as adjusting the fuel flow.

In some embodiments, the apparatus 205 is configured to be connectable to a public network 142, such as Internet, directly via local connection or via a wireless communication network 170 over a wireless connection 134. The wireless connection 134 may comprise a mobile cellular network, a satellite network, or a wireless local area network (WLAN), for example. The wireless communication network 170 may be connected to a public data communication network 142, for example the Internet, over a data connection 136. The apparatus 205 may be configured to be connectable to the public data communication network 142, for example the Internet, directly over a data connection that may comprise a fixed or wireless mobile broadband access. The wireless communication network 170 may be connected to a computing apparatus 150 of the system 100, over a data connection 138.

The system 100 may also comprise a plurality of satellites 174 in orbit about the Earth. The orbit of each satellite 174 is not necessarily synchronous with the orbits of other satellites and, in fact, is likely asynchronous. A global positioning system receiver apparatus such as the ones described in connection with preferred embodiments of the present disclosure is shown receiving spread spectrum global positioning system (GPS) satellite signals 132 from the various satellites 174.

In one embodiment, the apparatus 205 may set up local connections within the marine vessel 105 with at least one capturing device and a computer device. The capturing device, such as a sensor, may be integrated to the apparatus 205 or the marine vessel 105, attached to the hull of the marine vessel 105 and connected to the vessel control system or arranged as separate sensor device and connectable to the network 142 over a separate connection.

In some embodiments, the system may periodically perform automated readiness verification routines configured to evaluate whether the vessel satisfies one or more deployment readiness thresholds. Such routines may include battery sufficiency checks, fuel availability verification, air pressure verification, starter system diagnostics, alternator diagnostics, or sensor integrity validation.

In one embodiment, the system 100 includes a sensor device configured to be comprised by or connectable to the apparatus 205 over a local connection. The local connection may comprise a wired connection or a wireless connection. The wired connection may comprise Universal Serial Bus (USB), High-Definition Multimedia Interface (HDMI), SCART interface or RCA interface, for example. The wireless connection may comprise acoustic connection, Bluetooth™, Radio Frequency Identification (RF-ID) or wireless local area network (WLAN), for example. Near field communication (NFC) may be used for sensor device identification between the sensor device and the apparatus 205, for example.

In one embodiment, sensor devices, such as sensor devices 210, 240, installed within the marine vessel 105 and/or sensor devices associated with the engine 110 may generate a plurality of sensor data items which may be transmitted to apparatus 205. The apparatus 205 may in turn transmit the data to the computing apparatus 150 over the public network 142, for example. Sensor data items may be processed at the apparatus 205 before transmitting to computing apparatus 150 or they may be sent without further processing.

Sensor data may also be stored within the apparatus 205 before transmission over the network 142. Then again, transmitted sensor data may be stored/and or processed at the computing apparatus 150 or at the remote user device 160.

Each sensor data capturing device, e.g., sensor device 210, 240, installed within the marine vessel 105 and/or sensor devices associated with the engine 110, such as air pressure 334 and water temperature sensor 337 illustrated in FIG. 2, may capture and send sensor data as a real-time content or non-real time data to the apparatus 205. The apparatus 205 may then transmit the data to a computing apparatus 150, e.g., a remote server, and/or a remote user device 160 over a peer-to-peer connection formed over public network 142, for example.

The apparatus 205 may be connected to a plurality of different capturing devices and instruments and the apparatus 205 may be configured to select which sensor devices is actively collaborated with.

The apparatus 205 and its client application may allow the apparatus 205 to log into a vessel data service run on a computing apparatus 150, for example. In one embodiment, a proprietary application in the apparatus 205 may be a client application of a service whose server application is running on the server apparatus 150 of the system 100.

Real-time interaction may be provided between the apparatus 205 and the computing apparatus 150 to collaborate for marine vessel data over a network 142. Real-time interaction may also be provided between the apparatus 205 and the user computing device 160 to collaborate for marine vessel data over a network 142 via a connection 146.

A user of a client application (e.g., of a server application provided by computing apparatus 150) accessing it through user computing device 160 may need to be logged in with user credentials to a chosen service of the computing apparatus 150.

In one embodiment, the system 100 may comprise a computing apparatus 150, which comprises a storage device 152 for storing service data, service metrics and subscriber information, over data connection 146. The service data may comprise configuration data; account creation data; sensor data; sensor ID's; reference data items, user input data; real-time collaboration data; predefined settings; and attribute data, for example.

Alternatively, each of the sensor devices may be connected directly to the public network 142, such as Internet, via a direct local connection or via a wireless cellular network connection 138.

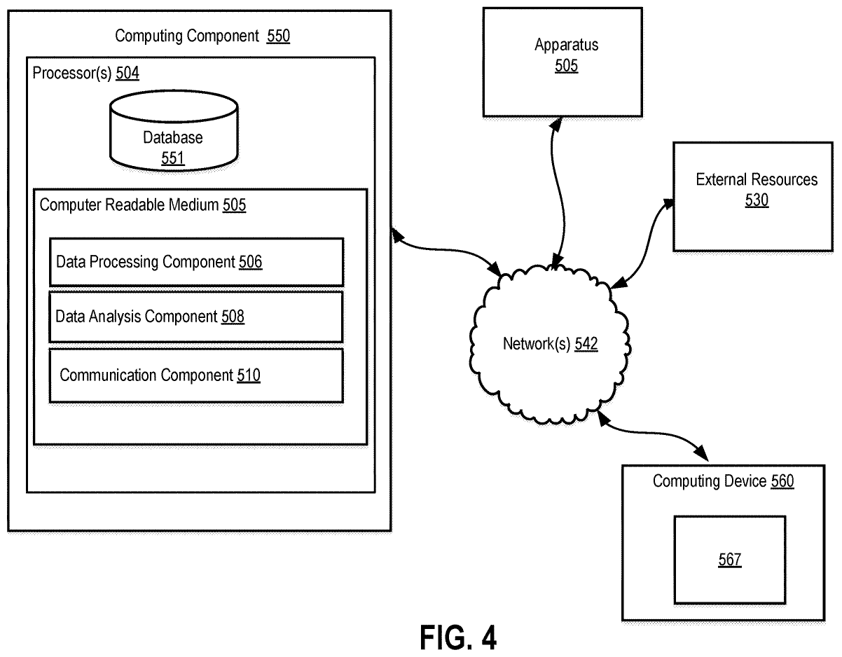

FIG. 4 illustrates a diagram of a computing component 550 which receives, and processes data transmitted by the remote monitoring assembly, for example a remote monitoring assembly 200 illustrated in FIG. 1, in accordance with the embodiments disclosed herein. For example, the computing component 550 may be in communication with an apparatus 505 (e.g., apparatus 205 of assembly 200 illustrated in FIG. 1).

This example computing component 550 may be in communication with a network 542. The computing component 550 may also be in communication with one or more external resources 550 (e.g., an online repository of weather data), a datastore 551, and a client computing device 560 that is in communication with network 542. External resources 550 may be located in a different physical or geographical location from the computing component 550.

As illustrated in FIG. 4, computing component 550 may be, for example, a server computer, a controller, or any other similar computing component capable of processing data. In the example implementation of FIG. 4, computing component 550 includes a hardware processor 504 configured to execute one or more instructions residing in a machine-readable storage medium 505 comprising one or more computer program components.

Hardware processor 504 may be one or more central processing units (CPUs), semiconductor-based microprocessors, and/or other hardware devices suitable for retrieval and execution of instructions stored in computer readable medium 505.

Hardware processor 504 may fetch, decode, and execute instructions 506-510, to control processes or operations for analyzing sensor data and determining real-time status of marine vessel's operability (e.g., determining whether vessel should be preemptively repaired). As an alternative or in addition to retrieving and executing instructions, hardware processor 504 may include one or more electronic circuits that include electronic components for performing the functionality of one or more instructions, such as a field programmable gate array (FPGA), application specific integrated circuit (ASIC), or other electronic circuits.

Hardware processor 504 may control processes/operations for generating real-time marine vessel sensor data and determine marine vessel operability based on sensor data using AI and/or machine learning techniques by executing instructions 506-510. Hardware processor 504 may execute instruction 506 (i.e., data processing component) configured to obtain sensor data (e.g., engine data, air pressure data, battery data, fuel data, and so on) provided by apparatus 505, and upload it to database 551. In some embodiments, sensor data may include data and time information, vessel information, location data, and other such data.

Hardware processor 504 may execute instruction 508 (i.e., data analysis component) configured to analyze sensor data obtained by component 506. Furthermore, instruction 508 may be configured to determine marine vessel operability based on sensor data using AI and/or machine learning techniques. For example, a trained AI model may determine whether the sensor data indicates a projected date for a malfunction of a particular part and/or system of a vessel thereby necessitating preemptive repairs. Hardware processor 504 may execute instruction 510 (i.e., communication component) to generate a visual representation of marine vessel operability. For example, a visual interpretation may include a graphical representation of an instrument panel including a plurality of gages displaying readings associated with the sensor data.

A computer readable storage medium, such as machine-readable storage medium 505 may be any electronic, magnetic, optical, or other physical storage device that contains or stores executable instructions. Thus, computer readable storage medium 505 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 505 may be a non-transitory storage medium, where the term “non-transitory” does not encompass transitory propagating signals. As described in detail below, machine-readable storage medium 505 may be encoded with executable instructions, for example, instructions 506-510.

In some embodiments, users of computing component 550 (e.g., vessel maintenance operators) may access computing component 550 via client computing device(s) 560. In some embodiments, the various below-described components of FIG. 4 may be used to initiate application 567 within client computing device 560. In some embodiments, application 567 may be configured to receive information transmitted by apparatus 505 and display operability determinations and determined by computing component 550.

In some embodiments, the client computing device 560 may include a variety of electronic computing devices, such as, for example, a smartphone, tablet, laptop, computer, wearable device, television, virtual reality device, augmented reality device, displays, connected home device, Internet of Things (IOT) device, an enhanced general packet radio service (EGPRS) mobile phone, a media player, a navigation device, a game console, a television, a remote control, or a combination of any two or more of these data processing devices, and/or other devices. In some embodiments, client computing device 560 may include a variety of electronic computing devices, for example, a computer wearable device, such as smart glasses, or any other head mounted display devices that can be used by a user (e.g., a maintenance operator). In some embodiments, the computer wearable device may include a transparent heads-up display (HUD) or an optical head-mounted display (OHMD). In some embodiments, client computing device 560 may present content to a user and receive user input. In some embodiments, client computing device 560 may parse, classify, and otherwise process user input. For example, client computing device 560 may store user input associated with vessel maintenance operator, as will be described in detail below.

The client computing device(s) 560 may be in communication with the computing component 550 to receive an indication of a user input at the device 560 and/or to provide an audible, visual, mechanical, or other output to the user. As such, the user device 560 may include, for example, a keyboard, a mouse, a display, a touch screen display, a microphone, a speaker, and/or other input/output mechanisms. In some embodiments, client computing device 560 may include one or more components coupled together by a bus or other communication link, although other numbers and/or types of network devices could be used.

The network 542, such as the network 142 in which the system of FIG. 1 or components thereof or components described herein may operate may include a local area network, the Internet, any other form of a network, or in any combination thereof, including proprietary private and semi-private networks and public networks. The network may comprise a wired network and/or a wireless network (e.g., a cellular network, wireless local area network, wireless wide area network, some combination thereof, and/or the like).

In some embodiments, the computing component 550 may communicate and interface with a framework implemented by the external system 530 using an application program interface (API) that provides a set of predefined protocols and other tools to enable the communication. For example, the computing component 550 can be used to receive data from OEM (e.g., repair instructions) used to determine vessel operability by the components of the computing component 550 describe herein.

The computing component 550 may be programmed to perform processing functions of the system and provide instructions to the client computing device 560 for display of the application 567. For example, maintenance operators may use remote monitoring application 567 running on the client computing device 560 and communicating with computing component 550 via network 542.

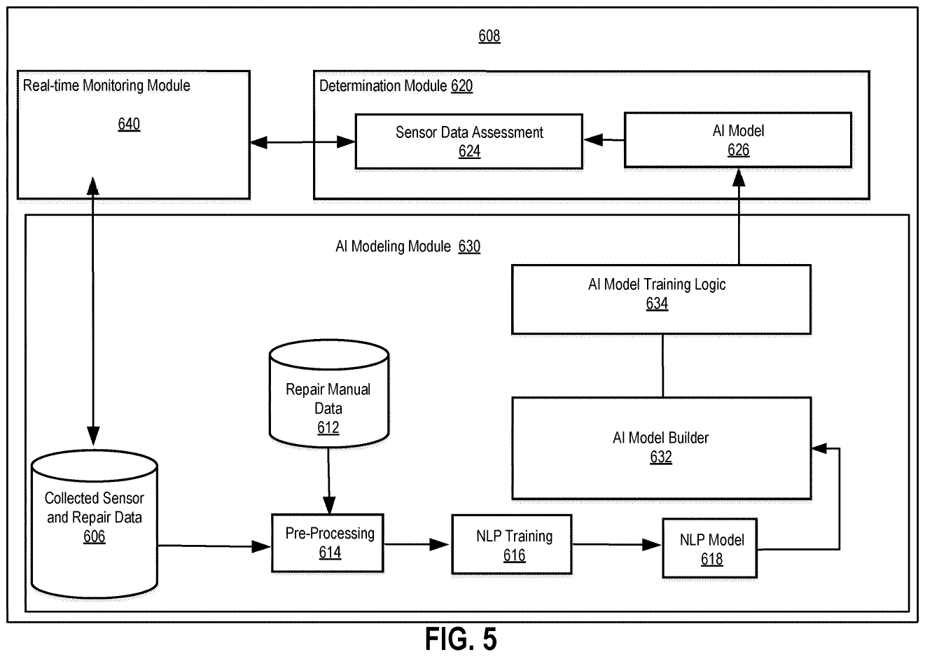

As alluded in reference to FIG. 5, data analysis component 508 may be used to analyze any or all the data held by computing component 550. For example, the data analysis component 508 may comprise an AI modeling system that may combine a number of machine learning models by using previously collected sensor data and/or repair data (e.g., data associated with repairs necessitated by the vessel) and retrieved from data server and/or database 551 to train the AI model.

In some embodiments, the database 551 may include a corpus of historical sensor and repair data associated with vessels served by the computing component 550. In some embodiments, sensor and repair data collected from multiple vessels may be aggregated to generate fleet-wide operability analytics, degradation trend analysis, benchmarking metrics, anomaly detection models, and continuously updated predictive maintenance models. Aggregated fleet-level data may improve prediction accuracy associated with projected component failures, maintenance intervals, and vessel readiness determinations.

The historical data may include sensor and/or repair data of similar marine vessels experiencing mechanical repair events. In some embodiments, this historic data may be generated from analysis of collected maintenance data before the occurrence of the repair event.

As used herein, a “database” refers to any suitable type of database or storage system for storing data. A database may include centralized storage devices, a distributed storage system, a blockchain network, and others, including a database managed by a database management system (DBMS). In some embodiments, an exemplary DBMS-managed database may be specifically programmed as an engine that controls organization, storage, management, or retrieval of data in the respective database. In some embodiments, the exemplary DBMS-managed database may be specifically programmed to provide the ability to query, backup and replicate, enforce rules, provide security, compute, perform change and access logging, or automate optimization. In some embodiments, the exemplary DBMS-managed database may be chosen from Oracle database, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, or objects. In some embodiments, the exemplary DBMS-managed database may be specifically programmed to include metadata about the data that is stored.

Having now described an example computing apparatus 550 for implementing example embodiments, FIG. 5 is a flowchart illustrating example operations of data analysis component 508, according to some example embodiments. The operations of FIG. 5 may be performed by the data analysis component 508 of the computing apparatus 550.

As illustrated in FIG. 5, the data analysis component 608 (i.e., the data analysis component 508 of FIG. 4) may include an AI modeling module 630, a vessel operability determination module 620, and a real-time monitoring module 640.

AI modeling module 630 may comprise a server computer system that combines a number of machine learning models 632 to produce a model 626, using historical sensor and repair collected from vessels and retrieved from data server and/or database 506 (illustrated in FIG. 5) to train AI model 634.

Vessel operability determination module 620 may comprise a server computer system configured to receive sensor data from real-time monitoring module 640. The sensor data assessment component 624 of the vessel operability determination module 620 applies the model 634 (generated and trained by the AI modeling module 630) and determines the operability of the vessel. In some embodiments, the vessel operability determination module 620 may generate a recommendation for scheduling maintenance events. For example, upon determining that the vessel is operable the module 620 may predict that a malfunctioning event may occur within a time period (which may fall within a threshold) and generate a recommendation that a maintenance is schedule before the occurrence of the malfunctioning event. The sensor data assessment component 624 communicates the determination to real-time monitoring module 640.

In some embodiments, the AI model may identify degradation trends associated with declining battery voltage, abnormal oil pressure fluctuations, coolant temperature drift, air cylinder leakage, repeated failed start attempts, alternator degradation, excessive fuel consumption, abnormal RPM behavior, humidity exposure, saltwater exposure, temperature cycling, seasonal environmental changes, or other conditions indicative of future mechanical failure.

In some embodiments, the AI model may generate projected maintenance windows, confidence scores, failure probabilities, or recommended service intervals associated with one or more vessel systems.

AI modeling module 630 receives collected sensor and repair data associated with vessels that includes sensor data (e.g., engine data including air pressure data, battery data, fuel data, oil pressure, coolant temperature, RPM data, AEK cylinder pressure, breathable air cylinder pressure, charge alternator voltage, system voltage, and such similar data) along with date and time information, vessel information, location data, and other such data, and repair data (e.g., malfunction information including malfunctioning part and/or system, malfunction cause, malfunction date and time information, vessel information, location data, repair performed, including part and/or system replaced, and so on).

The AI model may perform preprocessing of the collected sensor, vessel, and repair data received. For example, a preprocessing component 614 may condition any sensor, vessel, and repair data, and repair instruction data for optimum analysis. Ensuring data is complete and devoid of any duplicate records ensures accurate analysis. The results may be used by the language training 616 to train language model 618. For example, training 616 may use natural language processing (NLP) to perform analysis on sensor data, vessel data, repair data, and repair instruction data. The NLP may be or include any kind of NLP engine, such as a general-purpose NLP engine (e.g., the Natural Language Toolkit (NLTK), spaCy, Stanford NLP, or OpenNLP), a domain-specific (e.g., marine-specific) NLP engine, Lab NLP, or the Linguamatics), or a Large Language Model (LLM) of any kind(s).

In some embodiments, the preprocessing component 614 may transform the historical repair data, such as, e.g., malfunction information including malfunctioning part and/or system, malfunction cause, malfunction date and time information, vessel information, location data, repair performed, including part and/or system replaced, historical and current sensor data, such as, e.g., air pressure data, battery data, fuel data, oil pressure data, coolant temperature, RPM data, AEK cylinder pressure data, breathable air cylinder pressure data, charge alternator voltage data, system voltage data, and other such information, and OEM repair instruction data, including repair manuals, into feature vectors or feature maps such that the NLP model component 618 may generate a data category determination. Next, the NLP model component 618 may make category predictions based on features of the data.

Thus, in some embodiments, the preprocessing component 614 may receive the data, parse the data, and extract features according to a feature extraction algorithm. Data parsing and feature extraction may utilize methods depending on a type of data being received. For example, the preprocessing component 614 may include language parsing when the data includes text and character strings. Thus, in some embodiments, the preprocessing component 614 may include text recognition models including, e.g., a classifier for natural language recognition. However, in some embodiments, the data may be a table. In such a case, the preprocessing component 614 may simply extract features into, e.g., a feature vector directly from the data. However, in some embodiments, the data may include a combination of character strings, as well as structured data, such as tables, tuples, lists, arrays, among other. Thus, in some embodiments, the preprocessing component 614 may include model or algorithm for parsing the character strings and then extracting feature vectors from the structured data and the parsed character strings.

In some embodiments, the feature extraction algorithm may include, e.g., independent component analysis, an isomap, kernel principal component analysis (PCA), latent semantic analysis, partial least squares, principal component analysis, multifactor dimensionality reduction, nonlinear dimensionality reduction, multilinear PCA, multilinear subspace learning, semidefinite embedding, autoencoding, among others and combinations thereof. As a result, the preprocessing component 614 may capture the semantic meaning and context of the sensor data, repair data, and repair instruction (i.e., information which may influence the respective data category) by generating feature vectors having, e.g., text structure or text description, or frequency of certain words, among other possible features. For example, the textual description and the title or name of the repair instruction may be converted into a feature vector using techniques such as Bag-of-Words (BoW), Term Frequency-Inverse Document Frequency (TF-IDF), or word embeddings (e.g., Word2Vec, GloVe).

The AI modeling module 630 retrieves sensor and repair data from database 606 and OEM repair manual data from database 612.

Machine learning may involve identifying and recognizing patterns in existing data in order to facilitate making predictions for subsequent data. Models may be created based upon example inputs in order to make valid and reliable predictions for novel inputs. In some embodiments, the machine learning algorithm is a convolutional neural network (CNN); in some embodiments, the machine learning algorithm is a deep neural network (DNN); in some embodiments, the machine learning algorithm is a recurrent neural network (RNN). It is advantageous to use machine learning algorithms that are particularly adept at finding patterns (e.g., CNNs).

AI model builder 632 uses the NLP model 618 to generate the AI model 626.

In some embodiments, the AI model builder 632 may include, e.g., machine learning models, such as, e.g., one or more exemplary AI/machine learning techniques chosen from, but not limited to, decision trees, boosting, support-vector machines, neural networks, nearest neighbor algorithms, Naive Bayes, bagging, random forests, and the like.

Machine learning may involve identifying and recognizing patterns in existing data in order to facilitate making predictions for subsequent data. Models may be created based upon example inputs in order to make valid and reliable predictions for novel inputs. In some embodiments, the machine learning algorithm is a convolutional neural network (CNN); in some embodiments, the machine learning algorithm is a deep neural network (DNN); in some embodiments, the machine learning algorithm is a recurrent neural network (RNN). It is advantageous to use machine learning algorithms that are particularly adept at finding patterns (e.g., CNNs).

In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

The machine learning algorithm may be a supervised learning algorithm, employ decision trees, make use of an artificial neural network, make use of Bayesian statistical analysis, or combinations thereof. In this regard, a processor or a processing element may be trained using supervised or unsupervised machine learning, and the machine learning algorithm may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs. It should be understood that, over time, the AI modeling module 630 may accumulate a large pool of data on TEMPSCs or similar marine vessels. The data described above may be used (e.g., with a machine learning algorithm described above or by any other technique) to provide users with tools to estimate maintenance events that can be planned prior the marine vessel experiencing a fault. The machine learning algorithm may be trained using previously known data.

In some embodiments, vessel operability determinations may additionally or alternatively be generated using deterministic rules engines, threshold comparison systems, heuristic analysis systems, predefined diagnostic logic, or fault-condition evaluation routines independent of machine learning models. For example, the system may determine that a vessel is non-operable or requires maintenance based on predefined thresholds associated with battery voltage, oil pressure, coolant temperature, air pressure, fuel level, alternator output, engine start frequency, or combinations thereof.

The AI model training logic 634 can utilize a machine learning algorithm or other algorithm to construct and train a sensor data assessment model to be used in the sensor data assessment component 624, for example. The model 634 can be constructed to capture, based on the training data, the statistical relationship, if any, between a given feature value and a specific vessel for which the sensor data is being reviewed by the sensor data assessment component 624. The AI training model 634 may, for example, comprise the statistical correlations between a plurality of sensor characteristics, repair characteristics, and repair instruction characteristics of one or more vessel. A given feature value may have a different predictive utility for classifying each of the plurality of vessels to be evaluated.

One or more machine learning algorithms may be used to construct the vessel operability determination model, such as support vector machines that deploy stepwise backwards feature selection and/or graphical models, both of which can have advantages of inferring interactions between features.

For example, machine learning algorithms or other statistical algorithms may be used, such as alternating decision trees (ADTree), Decision Stumps, functional trees (FT), logistic model trees (LMT), logistic regression, Random Forests, linear classifiers, or any machine learning algorithm or statistical algorithm known in the art. One or more algorithms may be used together to generate an ensemble method, wherein the ensemble method may be optimized using a machine learning ensemble meta-algorithm such as a boosting (e.g., AdaBoost, LPBoost, TotalBoost, BrownBoost, MadaBoost, LogitBoost, etc.) to reduce bias and/or variance. Once a model is derived from the training data, the model may be used as a prediction tool to assess a likelihood a vessel may be safe to operate and/or is operable and/or a likelihood a repair within a time period may be required. Machine learning analyses may be performed using one or more of many programming languages and platforms known in the art, such as R, Weka, Python, and/or Matlab, for example.

A Random Forest classifier, which generally comprises a plurality of decision trees wherein the output prediction is the mode of the predicted classifications of the individual trees, can be helpful in reducing overfitting to training data. An ensemble of decision trees can be constructed using a random subset of features at each split or decision node. The Gini criterion may be employed to choose the best partition, wherein decision nodes having the lowest calculated Gini impurity index are selected. At prediction time, a “vote” can be taken over all of the decision trees, and the majority vote (or mode of the predicted classifications) can be output as the predicted classification.

The sensor data assessment component 624 of the vessel operability determination module 620 analyzes current sensor data received from real-time operating module 640. Sensor data assessment component 624 utilizes the trained AI model 626 to make a determination as to the present operability of a vessel. In some embodiments, the determination may refer to operability within a future time period, e, g., within a week, a month, a quarter, and so on. In some embodiments, the sensor data assessment component 624 may employ a plurality of components.

The real-time monitoring module 640 may receive the determination including vessel operability determination and a recommendation related to scheduling a maintenance event from the vessel operability determination module 620. The module 640 may transmit the data for storage within a database as well as communicate the findings to communication component (e.g., communication component 510 of computing apparatus 550 illustrated in FIG. 4). In some embodiments, the communication component 510 may be configured to generate a graphical representation of the sensor data received from apparatus 505 (illustrated in FIG. 4), and an operability determination and a maintenance recommendation.

In some embodiments, the apparatus 205 and/or computing apparatus 150 may be configured to receive remote control commands from an authorized remote operator device. Such remote commands may include remote engine start commands, remote engine stop commands, remote readiness verification routines, remote battery switching commands, remote actuator testing commands, remote sensor calibration operations, remote diagnostic routines, or remote firmware and configuration updates associated with the remote monitoring assembly.

In some embodiments, the system may selectively permit remote control operations only after satisfying one or more authentication, authorization, or safety verification procedures. In some embodiments, remote control functionality may be disabled while the vessel is occupied or deployed.

In some embodiments, the remote monitoring assembly may automatically execute one or more readiness verification routines configured to evaluate whether the vessel satisfies predefined deployment-readiness criteria associated with battery condition, fuel availability, air pressure, engine starting capability, alternator output, sensor functionality, or communication availability.

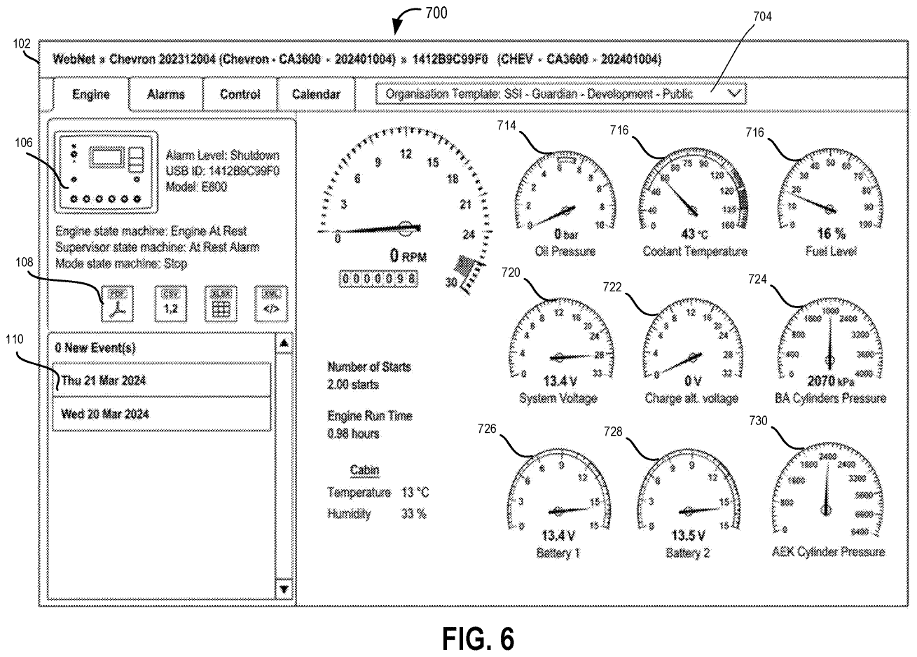

Turning now to FIG. 6, a user may utilize a graphical user interface (GUI) 700 to view a graphical representation of an instrument panel 720 generated by the system 100. The GUI 700 may be part of the real-time experience of the client application 567 illustrated in FIG. 4. In one example, the GUI 700 may be presented on a display of a client computing device, such as a standalone computer, tablet, mobile phone, television, virtual reality device, augmented reality device, wearable device, or other display-enabled computing device.

The GUI 700 may include a header region, a navigation region, a status region, an event region, and an instrument panel region. The header region may identify a vessel, organization, template, controller, or monitoring account. The navigation region may include selectable interface controls for viewing engine data, alarms, control functions, calendar information, reports, exported data, or other monitoring information. The status region may display controller information, alarm level information, engine state information, supervisor state information, mode state information, or communication status information. The event region may display new events, historical events, alerts, fault records, maintenance records, or date-based event entries.

The instrument panel region may include graphical representations of gauges, numerical values, labels, or other visual indicators associated with monitored vessel parameters. For example, the instrument panel region may display one or more of a tachometer, an oil pressure gauge, a coolant temperature gauge, a fuel level gauge, a system voltage gauge, an alternator charge voltage gauge, a breathable air cylinder pressure gauge, an auxiliary emergency kit cylinder pressure gauge, battery voltage gauges, cabin temperature information, cabin humidity information, number of starts, engine run time, or other operational parameters.

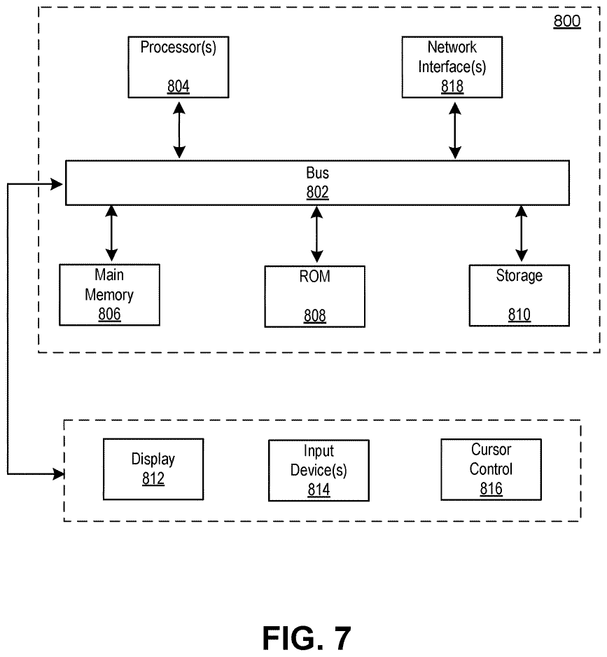

The graphical representations of the gauges may reflect readings obtained from physical sensors, gauges, switches, circuits, or instrument panel connections of the marine vessel, including the instrument and start panel 120 illustrated in FIG. 1. The data associated with the readings may be generated, processed, or transmitted by the remote monitoring assembly 200 and/or the communication component 510 of FIG. 4. In some embodiments, the GUI 700 may display an operability determination, a readiness verification output, an alarm condition, a projected failure indication, or a maintenance recommendation associated with the marine vessel.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 7. Various embodiments are described in terms of this example computing module 800. After reading this description, it will become apparent to a person skilled in the relevant art how to implement the technology using other logical circuits or architectures.

FIG. 7 illustrates an example computing module 800, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 800. After reading this description, it will become apparent to a person skilled in the relevant art how to implement the application using other computing modules or architectures.

Referring now to FIG. 7, computing module 800 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display 812, input devices 814, or cursor control 816 to help facilitate interaction and communications between the processor and/or other components of the computing module 800.

Computing module 800 might also include one or more memory modules, simply referred to herein as main memory 806. For example, preferably random-access memory (RAM) or other dynamic memory might be used for storing information and instructions to be executed by processor 804. Main memory 806 might also be used for storing temporary variables or other intermediate information during execution of instructions to be executed by processor 804. Computing module 800 might likewise include a read only memory (“ROM”) 808 or other static storage device 810 coupled to bus 802 for storing static information and instructions for processor 804.

Computing module 800 might also include one or more various forms of information storage devices 810, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface or network interface(s) 818. Communications or network interface(s) interface 818 might be used to allow software and data to be transferred between computing module 800 and external devices. Examples of communications interface or network interface(s) 818 might include a modem or softmodem, a network interface (such as an Ethernet, network interface card, WiMedia, IEEE 802.XX or other interface), a communications port (such as for example, a USB port, IR port, RS282 port Bluetooth® interface, or other port), or other communications interface. Software and data transferred via communications or network interface(s) 818 might typically be carried on signals, which can be electronic, electromagnetic (which includes optical) or other signals capable of being exchanged by a given communications interface. These signals might be provided to communications interface 818 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 806, ROM 808, and storage unit interface 810. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for remote monitoring of a marine vessel, comprising:
a diesel engine that does not include an integrated electronic control unit (ECU);
a plurality of sensors installed on or in communication with the diesel engine, configured to measure operational parameters of the engine, including at least one of: oil pressure, air pressure, temperature, battery voltage, or fuel level;
a remote monitoring assembly configured to receive sensor data from the plurality of sensors, and to transmit the sensor data to a computing apparatus over a wireless communication network; and
a computing apparatus comprising a processor and non-transitory memory storing instructions that, when executed, cause the computing apparatus to:
receive and store the sensor data;
apply one or more AI models trained on historical sensor and repair data to determine a current or projected operability status of the marine vessel; and
generate a visual representation of the operability status.

2. The system of claim 1, wherein the plurality of sensors includes a fuel sender sensor installed within a fuel tank of the marine vessel.

3. The system of claim 1, wherein the remote monitoring assembly comprises:
analog and digital input ports;
at least one output port for actuating a fuel solenoid or start relay; and
at least one network interface for communication with the computing apparatus.

4. The system of claim 1, further comprising a graphical user interface configured to display a simulated instrument panel representing current sensor readings and operability status.

5. The system of claim 1, wherein the remote monitoring assembly includes a solar port configured to accept input from a solar panel for power supply.

6. The system of claim 1, wherein the AI model includes a machine learning algorithm selected from the group consisting of: random forest, convolutional neural network (CNN), recurrent neural network (RNN), or gradient boosting machine.

7. The system of claim 1, wherein the computing apparatus is configured to issue a maintenance recommendation based on a predicted malfunction or degradation trend detected from the sensor data.

8. The system of claim 1, wherein the remote monitoring assembly is configured to interface with the sensors using at least one of: Universal Serial Bus (USB), Ethernet, wireless local area network (WLAN), Bluetooth™, or near field communication (NFC).

9. The system of claim 1, wherein the computing apparatus aggregates sensor data across multiple vessels and stores the data in a database for AI model training and fleet-wide analysis.

10. The system of claim 1, wherein the remote monitoring assembly is retrofitted into an existing TEMPSC vessel not originally configured for digital telemetry or ECU-based diagnostics.

11. A method for remotely monitoring the operability of a marine vessel having a diesel engine without an integrated electronic control unit (ECU), the method comprising:
receiving, at a remote monitoring assembly installed on the marine vessel, sensor data from a plurality of sensors coupled to the diesel engine, the sensor data including at least one of: oil pressure, fuel level, battery voltage, temperature, or air pressure;
transmitting, by the remote monitoring assembly, the sensor data to a computing apparatus via a wireless communication network;
processing, by the computing apparatus, the sensor data to generate one or more derived parameters indicative of engine performance;
applying, by the computing apparatus, a machine learning model trained on historical sensor and repair data to the processed sensor data;
determining, based on the applied model, a present or predicted operability status of the marine vessel;
generating, by the computing apparatus, a graphical representation of the operability status; and
transmitting the graphical representation to a user interface for display to a remote operator.

12. The method of claim 11, further comprising installing the plurality of sensors on a TEMPSC vessel not previously equipped with digital telemetry capabilities.

13. The method of claim 11, wherein the machine learning model comprises a convolutional neural network trained to predict failure events based on multivariate time-series data.

14. The method of claim 11, wherein the remote monitoring assembly further comprises analog input ports, digital outputs to actuate engine components, and at least one power input from a solar panel.

15. The method of claim 11, further comprising logging the sensor data in a centralized database for fleet-level monitoring and model retraining.

16. The method of claim 11, wherein the operability status includes a confidence score and a recommended preemptive maintenance window.

17. A retrofit remote monitoring system for a marine survival craft, comprising:
a marine survival craft comprising a diesel engine lacking an integrated electronic control unit (ECU) or integrated digital engine management system;
a plurality of analog sensors configured to generate analog sensor signals associated with one or more operational parameters of the diesel engine or one or more critical systems of the marine survival craft;
a retrofit remote monitoring assembly electrically coupled to the plurality of analog sensors, the retrofit remote monitoring assembly comprising:
analog input circuitry configured to receive the analog sensor signals;
analog-to-digital conversion circuitry configured to convert the analog sensor signals into digital telemetry data; and
a wireless communication interface configured to transmit the digital telemetry data over a wireless communication network; and
a remote computing apparatus configured to:
receive the digital telemetry data;
determine an operability status of the marine survival craft based on the digital telemetry data; and
generate at least one of a maintenance recommendation, projected failure indication, or readiness verification output associated with the marine survival craft.

18. The retrofit remote monitoring system of claim 17, wherein the retrofit remote monitoring assembly is electrically coupled to at least one preexisting gauge, switch, relay, solenoid, wiring harness, battery circuit, or instrument panel connection of the marine survival craft.

19. The retrofit remote monitoring system of claim 17, wherein the retrofit remote monitoring assembly comprises signal conditioning circuitry including at least one of filtering circuitry, amplification circuitry, voltage normalization circuitry, isolation circuitry, multiplexing circuitry, or calibration logic.

20. The retrofit remote monitoring system of claim 17, wherein the operability status indicates at least one of engine starting capability, propulsion readiness, battery readiness, fuel availability, air pressure sufficiency, alternator condition, or emergency deployment readiness.
